(19) United States
(12) Patent Application Publication
(10) Pub. No.: US 2004/0015700 A1
(43) Pub. Date: Jan. 22, 2004

(54) Attestation label system for marking and checking the legally correct nature of proprietory products and method for indicating the legalized status such products brought into commerce

(76) Inventor: Imre Kokenyesi, Budapest (HU)

Correspondence Address: ANTHONY H. HANDAL, KIRKPATRICK & LOCKHART, LLP, 599 LEXINGTON AVENUE, 31ST FLOOR, NEW YORK, NY, 10022-6030, US

(21) Appl. No.: 10/399,188

(22) PCT Filed: Oct. 17, 2001
(86) PCT No.: PCT/HU01/00101

(30) Foreign Application Priority Data
Oct. 17, 2000 (HU) P0004054

(51) Int. Cl. H04L 9/00

(52) U.S. Cl. 713/179

(57) ABSTRACT

Attestation label system for marking and checking the licensed legal status of products, wherein the products (3) are provided with respective attestation labels (10) before they are brought into sale, the affixed attestation label (10) cannot be removed from the associated product (3) without being injured, the surface of the attestation labels (3) comprise structures rendering copying and reproduction very difficult and a code field (14) divided into a first and a second domain (12, 13), the first domain (12) comprises a code characteristic to the owner of rights (1) and/or to the limitations of the license, and the second domain (13) comprises an individual code characteristic to the particular product (3) associated with the attestation label (10). The system is operated by a service provider (4) having a database (5) storing data both of said domains (12, 13); the database (5) following an accessibility check allows through a communication line (16) individual retrieval of said data, and said database (5) comprises information regarding the persons authorized for using the service and regarding the authorization.

The invention relates to an attestation label system for marking and checking the licensed legal status of goods and to a method for marking the licensed status of any particular good which has been brought into sale.

A significant portion of branded or other proprietary goods brought into sale is under trademark or copyright protection. The right providing such protection serves as a guarantee for the consumers on the quality and originality of the goods concerned. This confidence constitutes a vast commercial potential, which forms an economic basis for creating new products. The unauthorized utilization of this confidence provides a significant profit for the illegal users; however, it injures consumer's interest both in direct and indirect ways. The legal protection systems provide a legal guarantee for the owners of rights, which serve, however, only as a tool allowing them to act against those injuring their rights. In connection with actual products appearing on the market it is very difficult and often impossible to determine whether the product is licensed or not. Efficient legal protection can be provided only if the rightful and unauthorized products can be easily and quickly distinguished from each other.

The non-licensed status can be the result of the fake nature of a product i. e. it has not been manufactured by the owner of rights or by the license thereof, but the genuine nature of the product is not a sufficient condition of authenticity. If a product being licensed in a country is brought for sale illegally in the territory of another country, then such a sale will qualify as an illegal action as long as an international agreement is made on the exhaustion of rights. A product manufactured by a rightful licensee above the agreed quantity will also qualify as non-licensed.

Numerous ways are known for the certification of the genuine nature of goods that all include the marking of the products with a kind of certification label. Such methods cannot make distinction in case of products injuring either country or quantity limitations. The protection of such labels against falsification is also not perfect.

The task of the invention is to provide a solution that is capable of indicating and checking the licensed or authentic nature of a product within national or even international sphere.

This task has been solve by providing an attestation label system, wherein the products are provided with respective attestation labels before they are brought into sale, the affixed attestation label cannot be removed from the associated product without being injured, the surface of the attestation label comprises structures that render copying and reproduction very difficult and it comprises furthermore a code field divided into a first and a second domain, the first domain comprises a code characteristic to the owner of rights and/or to the limitations of said license, and the second domain (13) comprises an individual code characteristic to the particular product associated with the attestation label, and the system is operated by a service provider that has a database storing data both of said domains, and the database carries out an accessibility check and allows through a communication line the individual retrieval of said data, and the database comprises information regarding the persons authorized for using said service and regarding said authorization.

It a preferable embodiment the first domain comprises field sections identifying the owner of rights, the licensee, the geographic limitations of the right and the type of the product, respectively.

It is preferable if the second domains of the code fields comprise respective individual serial numbers of the associated products coded and sequenced according to a coding program selected by the service provider from predetermined coding programs.

In a preferable embodiment following the printing of each group of the attestation labels at a printing office, a “printing completed” status is written in the database at the service provider beside the data of the code fields of the group concerned.

The code fields are preferably machine-readable e.g. constituted by bar codes, and the two domains define a pair of bar code fields.

It is also preferable if following the printing of each group of attestation labels at a printing office, the data in the code fields of the labels in the group are written in the data base at the service provider.

According to the invention a method has also been provided for marking and checking the licensed legal status of a product that the product can be brought into sale, wherein an owner of rights has given a license to a licensee for said sale under predetermined terms. During the method the product is provided with an attestation label, and in an authorized printing office predetermined structures are provided on the attestation label which are very difficult or impossible to reproduce, according to the invention a service provider is informed about data relating to the license and the product, wherein the service provider has the task of producing of and keeping record on the attestation labels; prior to releasing a series of licensed products for sale, data relating to the series, to the owner of right, to the licensee, to predetermined terms of the license and to the product are stored into a database at the service provider; these data and an individual marking being preferably a serial number of the product on said attestation label are recorded directly or in a coded form on the attestation label; this recorded attestation label is affixed to the particular product; and for authorized persons access is provided to the database to impose a request directed to any particular one of the products for checking the licensed nature thereof.

In case of products sold in larger quantities the bales of multiple packed and shipped products are provided with respective bale attestation labels that comprise the characteristics of the associated bales.

The attestation label system according to the invention and the method actually solves the task set, because in case of each product it certifies the licensed nature in a well visible manner, and enables it checking in a fast and easy way.

The invention will now be described in connection with preferable embodiments, in which reference will be made to the accompanying drawings, In the drawing:

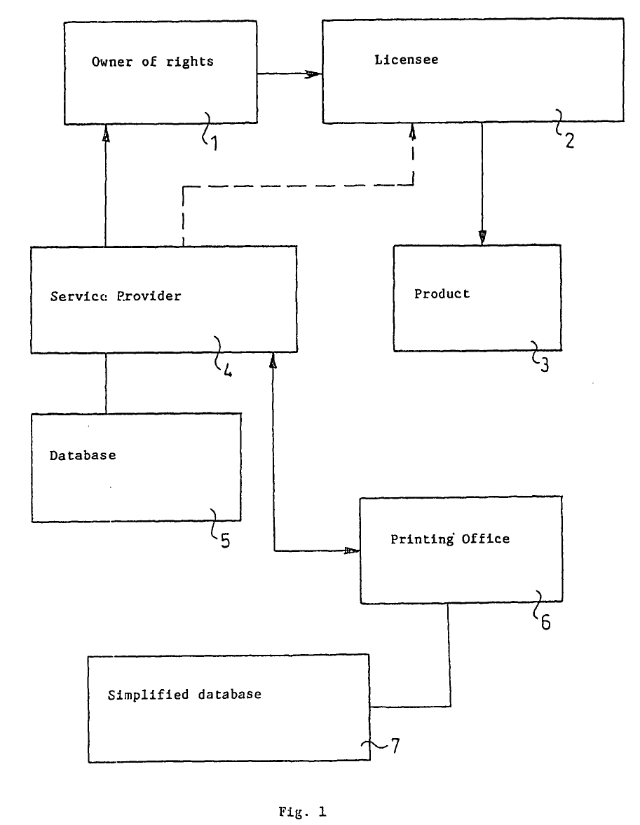

FIG. 1 is the schematic block diagram of the system according to the invention;

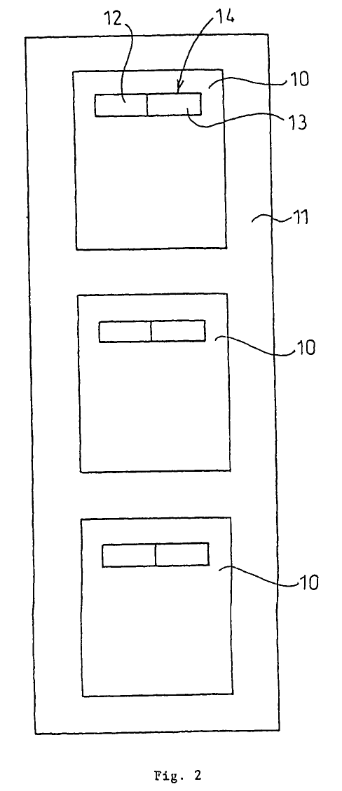

FIG. 2 shows an embodiment of the attestation label; and

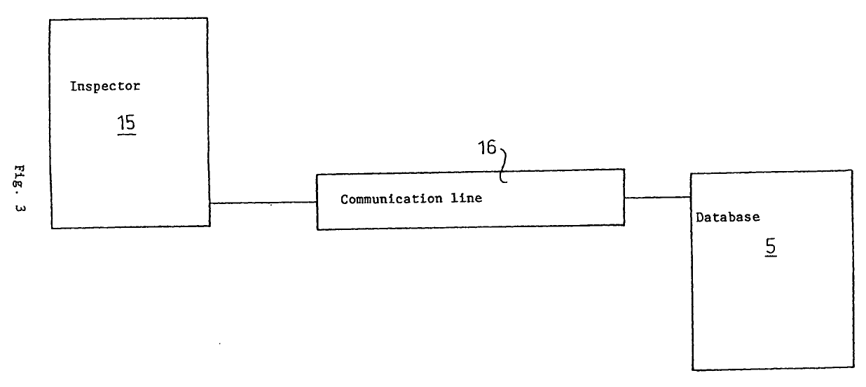

FIG. 3 is the block diagram of the information retrieval sub-system.

FIG. 1 shows how the system according to the invention is structured. The basic function of the system is to protect the interest of the owners of rights in an efficient and easily controllable way. In the functional diagram of FIG. 1 the block designated as owner of rights 1 refers to the original owner of a trademark, copyright or know how right. The product on which the attestation label is applied is generally not manufactured or brought to the market by the owner of rights himself, but these tasks are carried out by one or more manufacturing or trading enterprises in each country who obtained a license for doing so. Licensee 2 is in contractual relationship with the owner of right 1, and such a relationship comprises in connection with the concerned product 3 at least clauses that define the limits of the activities of the licensee. This can be characterized by the definition of the product 3, of the territorial limits and term of expiration of the license, of limitations concerning the number of products and by the license fee of royalty to be paid.

A service provider 4 has the duty of providing attestation labels for the products 3 upon orders imposed by either the owner of rights I or by the licensee 2. The service provider 4 has a database 5 of high capacity, which enables the storage and selective retrieval of data and information connected with the issuance of attestation labels and with the rights to issue such labels. The service provider 4 is both in contractual and business relationship with a printing office 6. The sole task of the printing office 6 is to prepare the attestation labels in a predetermined form and to provide them with respective individual identification codes. The printing office 6 has to make the attestation labels in a predetermined state-of-the-art format sufficiently protected against falsification that comprises a unique pattern, a carrier being impossible to be reproduced and a holographic or other marker expressing originality. Blank attestation labels can be stored at the printing office 6 attached to an appropriate carrier band, they will become usable only after being provided with respective identification codes. The service provider 4 imposes orders to the printing office 6 according to requests received, and gives information on the content of a first code field, and defines the number of articles in a series required for preparing the serial numbers of the labels constituting second code fields, furthermore it defines the code and starting number to be used for generating the respective serial numbers. Alternatively, the computer system of the service provider 4 prepares a printing database corresponding to the actual requests and forwards it to the printing office 6 either on a storage carrier or through a protected data line, where the attestation labels will be individually generated, or in other words ‘personalized’.

From the printing office 6 the generated attestation labels will be transmitted to the final user by means of the service provider 4. The data of the attestation labels will be stored in the database 5 immediately after they have been generated and prepared.

Agreements concluded between the owner of rights 1 and the service provider 4 determine the conditions of the payments of the service fee. Any given product 3 can be provided with an attestation label only after the licensee 2 has verified his right for use. The service agreement should contain the conditions and fees for using the attestation label.

FIG. 2 illustrates the structure of an attestation label 10. The attestation label 10 is arranged on carrier 11 from which it can easily be removed manually or in an automated manner without the danger of being injured. Following the removal from the carrier 11 and affixation on the product 3 the attestation label 10 cannot be removed any more without being hurt. On the rear side of the attestation label 10 an adhesive layer is provided, and its adhesion force as well as perforations or grooves made in the material of the attestation label ensure this property. From this point of view the attestation label 10 is similar to highway pass labels. In case if either at the owner of rights 1 or at the licensee 2 a group of attestation labels get injured before they had been affixed on any product, they should be returned to the service provider 4 in their injured but recognizable states, and their data will be entered in the database 5 with a status code “injured”.

The attestation label 10 comprises a code field 14 that can be divided into a first domain 12 and a second domain 13, and the code field 14 can comprise a code that consists of either 8-8 alphanumeric characters (each of which can take 32 or 64 states) or of two sets of bar codes, each comprising 13-16 numeric characters. The domains 12 and 13 do not overlap and they can have any number of characters made according to bar code standards, thus they are machine-readable. In addition to the code field 14 the attestation label 10 comprises structures similar to those on bank notes or checks, and the structures consist of a predetermined pattern, a background and a hologram identifier. It is preferable if an inscription is also provided on the attestation label 10 that designates the task of the service. This inscription can be e.g. a certification mark such as “Licensed Product”, which is understandable in every country.

One of the most important features of the system according to the invention is the possibility of imposing individual questions. FIG. 3 shows the schematic arrangement how retrieval works. In the system inspector 15 can be the owner of rights 1 or selected or authorized personnel thereof, it can designate the licensee 2, the service provider 4 or persons authorized by any of the aforementioned entities including authorities or private inspectors (e.g. customs or finance officers, police, consumer protection agencies or private investigators). The inspector 15 receives together with the authorizing license a code that comprises the limits of his authorization. The inspector 15 gets into connection with the database 5 through communication line 16 that can be a mobile phone, telephone or internet connection. When the connection has been established, the authorization code is given together with the code field of the attestation label to be controlled (this occurs generally in an automated manner). In case if the data under search fall in the range permitted by the authorization, the database 5 retrieves the code defined by the code field and if an attestation label issued with such a code is found, a simple “yes” response is issued, whereby the licensed nature of the attestation label and thereby of the associated product is confirmed. The verification process is very fast and simple. The use of the attestation label system is particularly preferable when the licensed nature of imported goods protected by copyright protection should be proven before the customs office. As it is generally known, the fact whether a product is under copyright protection and if this is the case, who is the rightful owner, cannot be established as easily as in case of trademarks. Owing to this ground it is difficult to initiate a customs inspection and to stop the importation of unauthorized products at the border. The use of the attestation label system according to the invention assists also in overcoming such problems. If the competent customs offices obtain right to access the system, then they can easily check the legalized nature of products bearing attestation labels. This naturally requires that the foreign exporting party receive the attestation labels and affix them on the products before shipment is made. Such a condition can easily met with the co-operation of the contracting parties.

The retrieval program of the database 5 is designed to allow responses to individual requests only, i.e. it does not make possible for the requesting person to collect comprehensive information on the data associated with the particular owner of rights or with the given product. It is particularly prohibited that any owner of rights can obtain any information on the data of other owners of rights.

In the following an example will be given how the code field 14 is structured. The first domain 12 comprises eight codes each of which can take 64 values, and the eight codes are divided into four times two sections. The first section identifies the owner of rights 1. The second section identifies the licensee 2. The third section defines the geographic area within which the associated rights are valid, and this area can be a country, a group of countries, a regional customs union or any area that can be defined as area in international commercial agreements. The fourth section identifies the product itself that relates generally rather to a product group, since in international agreements licenses are predominantly granted to product families covering similar products.

In case if the system according to the invention will be so widely used that the length of such sections will be insufficient to distinguish the required information, the length of such sections can be increased.

There are products which are handled and shipped in bales. Each bale contains a high number of individual products. For facilitating control, the respective bales can be provided with so called collective attestation labels, which regarding their design and content are identical to the aforementioned attestation labels, and the difference lies only in that the product is constituted here by the bale of products. In the database it is advisable to create in such cases bale files. It depends on the nature of the products whether it is worthwhile to affix individual attestation labels on the products in a bale. In case of chewing gums e.g. there is no sense for using individual labels. In case of trading with T-shirts, or other branded clothing articles the use of individual labels in addition to the labels on the bales can be reasonable.

An advantage of the system according to the invention lies in that the data of the first domain 12 and the coding of such data are easily recognizable and they are public at least for those knowing and using the system. The alphanumeric marking of the sections provides an easy way for identification. A false designation can be recognized before the serial number of the product is checked in the system, when the visible features of the product 3 are different from the data in the easily recognizable first domain 12.

The second domain 13 that serves for the individual identification of the product is not a simple serial number, i.e. from a code associated with a product the identification number of either the preceding or subsequent product cannot be obtained in an easy way. The coding is defined by the agreement between the service provider 4 and the printing office 6 or by the coding defined by the service provider 4. The coding can involve the generation algorithm of the alphanumeric characters, the sequence of the characters or any other parameter that can define ciphering. Such a data handling makes the system fully protected against being falsified, because if any falsifier could make a copy from the data of any particular product, he cannot make more copies from it, since that code can be used for that particular product only. The system informs namely the requester that the same product has been questioned by the second times.

In the actual design the system according to the invention is more complex than shown in this example. The hierarchy of the authorized persons is generally more complex than shown in FIG. 1. The relationship between the original owners of rights 1 and the final user can include a number of steps that involve generally the manufacturer, the trader, the importing party, the wholesale dealer and retailer. Regarding the attestation label agreement, any of the listed persons can qualify as licensee 2. The database 5 should therefore be able to handle 4-5 levels regarding the right to use issue.

In case if the code field 14 is made by a bar code, the advantages of machine readability can be utilized, and the access requests can occur through the internet and/or through a suitably programmed mobile phone, and in such occasions the response can comprise in addition to the simple yes/no answer also the data of the product and the name of the owners of rights.

The advantages of the attestation label system according to the invention lie in that the system can be broadened to cover the whole international exchange of goods, the licensed product can well be distinguished from faked and unauthorized original products, the easy control is available for any authorized forum, the application of the system is cheap and it does not impose any limitation on the freedom of concluding agreements by the owners of rights but it takes into account the terms of such agreements.

1. Attestation label system for marking and checking the licensed legal status of products, characterized in that said products (3) being provided with respective attestation labels (10) before having been brought into sale, the affixed attestation label (10) cannot be removed from the associated product (3) without being injured, the surface of said attestation label (3) comprising structures making copying and reproduction very difficult and a code field (14) being divided into a first and a second domain (12, 13), said first domain (12) comprises a code characteristic to the owner of rights (1) and/or to the limitations of said license, and said second domain (13) comprises an individual code characteristic to said particular product (3) associated with said attestation label (10), said system being operated by a service provider (4) having a database (5) storing data both of said domains (12, 13) and said database (5) following an accessibility check allowing through a communication line (16) individual retrieval of said data, and said database (5) comprising information regarding the persons authorized for using said service and regarding said authorization.

2. The system as claimed in claim 1, characterized in that said first domain (12) comprises field sections identifying the owner of rights (1), the licensee (2), the geographic limitations of the right and the type of the product (3), respectively.

3. The system as claimed in claim 1, characterized in that said second domains (13) of the code fields (14) comprise respective individual serial numbers of the associated products (3) coded and sequenced according to a coding program selected by the service provider (4) from predetermined coding programs.

4. The system as claimed in claim 1, characterized in that following the printing of each group of said attestation labels (1) at a printing office (6) a “printing completed” status being written in said database (5) at said service provider (3) beside the data of the code fields (14) of the group concerned.

5. The system as claimed in claim 1, characterized in that said code fields (14) being machine-readable.

6. A method for marking and checking the licensed legal status of a product for being brought into sale, wherein an owner of rights (1) has given a license to a licensee (2) for said sale under predetermined terms, comprising the steps of providing said product (3) with an attestation label (1), and in an authorized printing office (6) providing on said attestation label (10) predetermined structures being very difficult or impossible to reproduce, characterized by the steps of: informing a service provider (4) about data relating to said license and said product (3), wherein service provider (4) having the task of producing of and keeping record on said attestation labels (10); prior to releasing a series of licensed products (3) for sale storing data relating to said series, to the owner of right (1), to the licensee (2), to predetermined terms of the licensee and to the product (3) into a database (5) at said service provider (4); recording said data and an individual marking being preferably a serial number of the product (3) on said attestation label (10) directly or in a coded form; using said recorded attestation label (10) associated with the particular product (3) in said step of providing said product (3) with an attestation label (10); and providing access to the database (5) for authorized persons to impose a request directed to any particular one of said products (3) for checking the licensed nature of the products (3).

7. The method as claimed in claim 6, characterized in that in case of products sold in larger quantities providing the bales of multiple packed and shipped products with respective bale attestation labels that comprise the characteristics of the associated bales.
